(19) United States
(12) Patent Application Publication
(10) Pub. No.: US 2002/0122686 A1
(43) Pub. Date: Sep. 5, 2002

(54) Game card marking device

(76) Inventor: David Guercio, East Amherst, NY (US)

Correspondence Address: Ronald S. Kareken, Esq., Jaeckle Fleischmann & Mugel, LLP, 39 State Street, Rochester, NY, 14614-1310, US

(21) Appl. No.: 10/072,224

(22) Filed: Feb. 7, 2002

Related U.S. Application Data
(60) Provisional application No. 60/272,656, filed on Mar. 1, 2001.

(51) Int. Cl. B05C 11/00

(52) U.S. Cl. 401/266; 401/6

(57) ABSTRACT

A versatile, ergonomic marking device for marking game cards such as bingo cards, having a container of a liquid ink and a porous sponge dabber by which to apply the ink, in which the container body is shaped to enable it to be held in various ways and the container head holding the dabber is positioned at an optimum angle relative to the container body to enable rapid play with a minimum of hand and arm motion.

### CROSS-REFERENCE TO RELATED APPLICATIONS

This application claims priority of U.S. Provisional Patent Application Serial No. 60/272,656, filed Mar. 1, 2001.

### FIELD OF THE INVENTION

The present invention relates to an accessory for playing bingo and other such games by marking numbers or other indicia on the game cards using a marking medium such as a translucent colored ink.

### BACKGROUND OF THE INVENTION

Translucent ink marking devices are well known in the prior art, including for use in playing games such as bingo. The bingo marking devices usually will include a plastic container to provide a reservoir for the ink, with an opening at one end that is covered by a porous sponge “dabber.” Typically, such marking devices will include a cap to enclose the dabber when not in use and are usually disposable after the ink supply is consumed. To mark the bingo card, the container is grasped by the container and inverted over the card with the dabber pressed against the card on the desired location in order to cause a predetermined amount of ink to flow through the dabber and be deposited on the card at that location. However, the marking devices known to applicants are not ergonomically well designed and prevent rapid play, because the angle at which they must held either will temporarily obscure the card, or increase the potential for fatigue, or both.

### SUMMARY OF THE INVENTION

The present invention relates to an improved ink marking device that is especially configured to enable the user both to hold the marker in any one of a number of ergonomically sound positions that are suited to the user and his or her physical conditions, and to clearly see the indicia simultaneously on a number of game cards, while in the process of marking, in all of those positions.

### BRIEF DESCRIPTION OF THE DRAWINGS

The features of the present invention can be best understood from the following description and the accompanying drawings, in which:

FIG. 1 is a side view of a preferred embodiment of a marking device according to the present invention;

FIGS. 2, 3, 4 and 5 are front, back, TOP and bottom views, respectively, of the preferred embodiment of FIG. 1;

FIG. 6 is a is a side view with the cap removed;

FIG. 7 cross-sectional view taken on line 7-7 of FIG. 2 with the cap removed; and

FIGS. 8, 9, 10 and 11 partially illustrate a few of the possible positions by which the marker may be comfortably held without obstructing the view of the game cards.

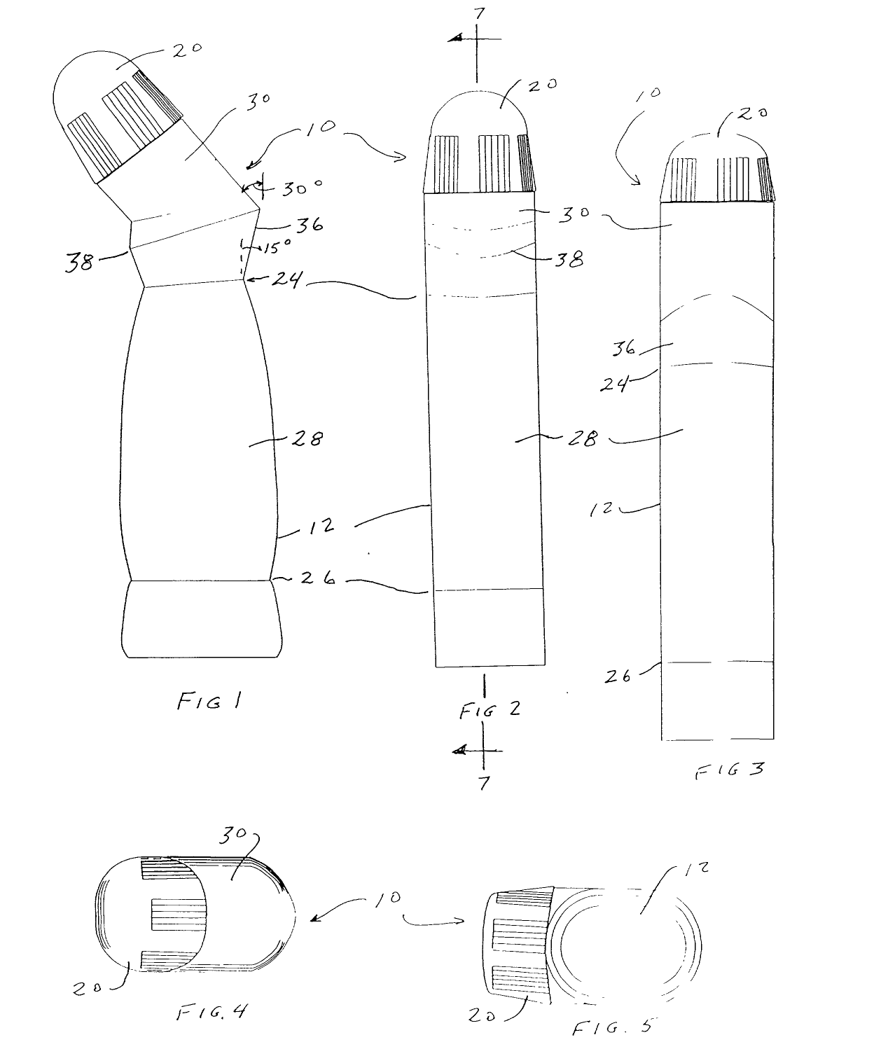

### DESCRIPTION OF THE PREFERRED EMBODIMENT

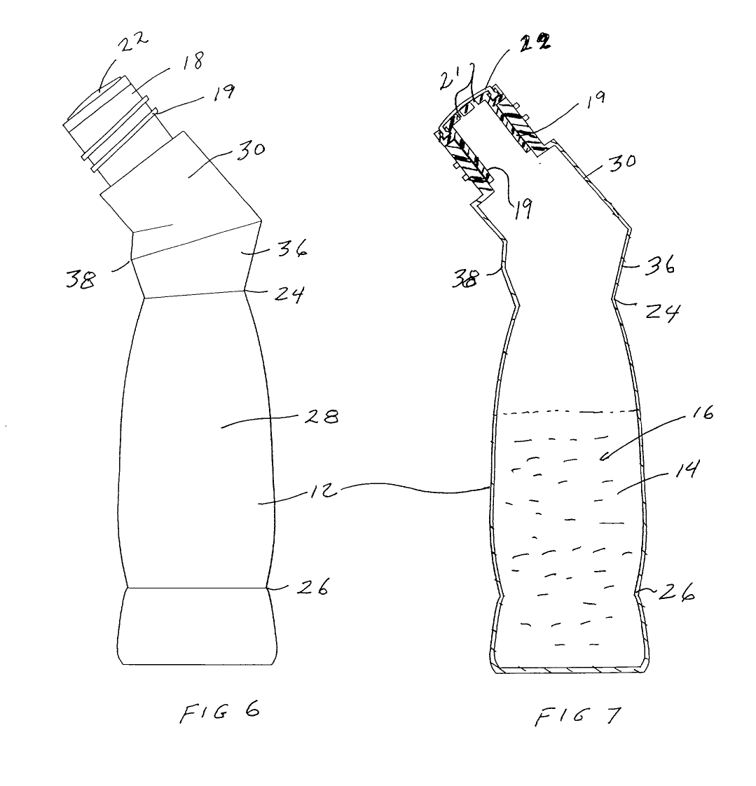

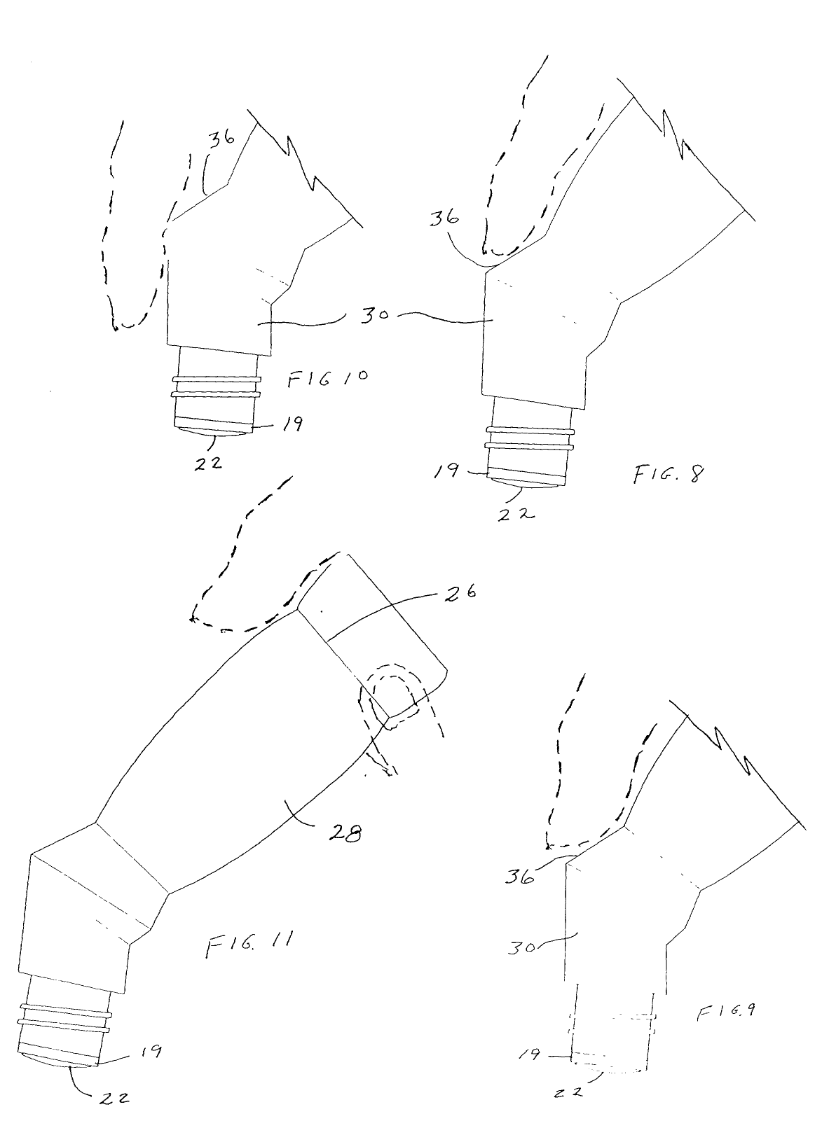

Referring now to the drawing, a marking device 10 according to our invention comprises a container body 12 made preferably of a molded plastic material which is formed to include an ink chamber 14 containing a suitable translucent ink composition 16. Integral with and at the top end of the container body 12 is an applicator head 30 having circular opening 18 the outer side of which is provided with an integrally molded thread 19 to receive a cap 20 when the marker 10 is not in use. Mounted in the opening 18 is a retainer insert 19 that is affixed to head 30 by adhesive or a press fit. Insert 19 at its top side includes a number of holes 21 patterned to control ink flow to a foam dabber 22 which is fixed to the insert 19 and covers the holes 21 as shown in FIG. 6. Dabber 22 acts as the applicator of the ink 16 when the marker 10 is inverted and the dabber 22 is pressed against the game card at the desired location.

The material compositions of the container 12, applicator head 30, cap 20 and insert 19, as well as those of the ink 18 and the dabber 22 may be selected from any number of suitable compositions which are known in the art for making ink marking devices and, accordingly, need not be described in further detail.

The present invention is particularly useful to bingo players who simultaneously play a large number of game cards in each bingo game and thus are required to scan the cards with rapid and a highly coordinated hand and eye movement to be able to mark the appropriate cards at the correct locations in a very limited period of time. Because bingo players very often have physical limitations because of age and the like, and often will play for long periods of time over many games, our invention is especially suited for that purpose.

Referring now specifically to the features of the invention, the container body 12 is configured with a grip 28 in a generally oval cross section with a circumferential girth at its center of about 4 and ½ inches. At the two ends of grip 28 are a pair of partially restricted neck portions 24 and 26 located as shown near the upper and lower ends of the body 12. The neck portions 24 and 26 are spaced from each other by a distance, e.g., about 2 and ¾ inches, approximating the spacing between the first and last fingers of a smaller adult hand and between the first and third fingers of a larger adult hand, both when comfortably spaced without undue muscle tension required. Located in the container body 12 above the upper neck portion 24 is the applicator head 30 which is molded integrally with body 12 at a preferred angle of about 30° relative to the grip 28. The top open end of head 30 containing the thread 19 is circular in order receive cap 20, whereas the dabber 22 is positioned and held by the retainer insert 19.

Further according to the invention, the lower end of applicator head 30 on its larger angle side is configured to include a substantially straight section 36 about ¾ inches in vertical length and at about 15° from the vertical axis of the container body 12, which is designed to serve as a control surface by which the marker 10 may be manipulated with the end of a finger. Thus, section 36 provides an optional surface at which the tip of a forefinger or other finger or thumb may be positioned to press the dabber 22 against a game card (see FIGS. 8 and 9). On the smaller angled side of the head is an outwardly rounded portion 38 which together with section 36 can provide a ready hand stop by which to quickly pick up the marker 10 from its standing rest while still having the hand in a position enabling the user quickly to move the marker 10 into the desired position for holding the marker 10 while playing a game. Similarly, section 36 also provides the option of enabling the user to place the upper joint of a forefinger at its top end to enable the user to use the end of a forefinger above the top joint as the means to apply the applicator pressure (see FIG. 10). As another example, marker 10 can be held securely at its bottom by neck portion 26 as shown by FIG. 11. In all of the holding options illustrated, as well as others that may now be apparent, it can be seen that the marker 10 can be held in a variety of comfortable positions while in use, without undue pressure on the wrist and hand joints, and still enabling it to be held in a position that optimizes visibility of the many game cards being played and scanned in the brief time available for each game call.

Although the present invention has been described in detail with reference to a preferred embodiment, the invention is not so limited, as other embodiments are possible within the spirit and scope of the following claims.

I claim:

1. A game marking device for marking game cards such as bingo cards, comprising a container body containing a liquid ink and an applicator head containing a porous dabber by which to apply the ink, the improvement in which the container body is shaped to enable it to be held in various ways and the applicator head holding the dabber is positioned at an optimum angle relative to the container body to enable rapid play with a minimum of hand and arm motion.

2. A game marking device according to claim 1 in which the container body is configured as a grip in a generally oval cross section with a pair of partially restricted neck portions located at the upper and lower ends of the body.

3. A game marking device according to claim 1 in which the angle is about 30°.

4. A game marking device according to claim 3 in which the applicator head includes a section angled outwardly from the container body and by which a user may use a finger or thumb to apply the dabber to the game cards.

5. A game marking device for marking game cards such as bingo cards having a container body with upper and lower ends and a chamber to receive marking ink, a dabber at the upper end by which to apply the ink, the improvement comprising a grip portion of the container body having a generally oval cross section with a generally vertical axis and upper and lower partially restricted end neck portions, the end neck portions spaced from each other at a distance approximating the spacing between the first and last fingers of a smaller adult hand and between the first and third fingers of a larger adult hand, a substantially flat bottom by which to support the marking device in a standing position when not being used; an applicator head supporting the dabber at the upper end of the container body and with an axis at a preferred angle of about 30° relative to the vertical axis of the grip portion; a collar portion between the grip portion and the applicator head, the collar portion having an axis at about 15° from the vertical axis of the grip portion, with the collar portion including a section at one side of sufficient length to be able to serve as a control surface by which the marking device may be manipulated with the end of a finger and at an opposite side defining a hand stop by which to quickly pick up the marking device from the standing position while still having the hand in a position enabling the user quickly to move the marking device into the desired position for applying ink.
